(19) United States
(12) Patent Application Publication
(10) Pub. No.: US 2004/0257455 A1
(43) Pub. Date: Dec. 23, 2004

(54) Method, apparatus, database, and program for image processing

(75) Inventor: Tatsuya Aoyama, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/816,194

(22) Filed: Apr. 2, 2004

(30) Foreign Application Priority Data
Apr. 3, 2003 (JP) (PAT. 100139/2003
Mar. 25, 2004 (JP) (PAT. 089393/2004

(51) Int. Cl. H04N 5/228

(52) U.S. Cl. 348/222.1

(57) ABSTRACT

Image enhancement processing can be carried out efficiently on image data obtained by a digital camera while a difference between models of digital cameras can be suppressed. Digital cameras are classified into groups of predetermined level ranges regarding characteristics of color, tone, sharpness and noise. Image processing conditions are also set for the respective groups in accordance with the level ranges thereof. When image enhancement processing is carried out on image data obtained by a the digital camera, the groups the digital camera belongs to are found for the respective types of characteristic, and the image processing conditions therefor are used for the enhancement processing.

### BACKGROUND OF THE INVENTION

1. Field of the Invention

The present invention relates to an image processing method and an image processing apparatus for enhancing image data obtained by a digital camera. The present invention also relates to a database and a program therefor.

2. Description of the Related Art

Various systems have been realized for providing services related to digital image data (hereinafter simply referred to as image data). For example, a system is in use for providing a storage service (including a browsing service) and a management service regarding image data obtained by a digital camera. Furthermore, a printing service system is also available for printing image data after carrying out image enhancement processing thereon.

As such a printing service system, a system has been known wherein image data uploaded by a user from a terminal to a server are printed by a printer in a mini-laboratory connected to a network after image enhancement processing is carried out thereon. In another system, image data having been subjected to image enhancement processing are stored in a server and only an address such as URL is sent to a mini-laboratory for indicating where the image data are stored. When the mini-laboratory accesses the server, the image data are downloaded thereto and printed.

As a method of carrying out image enhancement processing on image data, a characteristic of image data or a photographed scene is analyzed. The image enhancement processing is then carried out according to the characteristic or the scene.

Meanwhile, a digital camera comprises an optical system (such as a shutter, a flash, and an aperture), an imaging system (such as a CCD sensor and a signal processing unit), a control system (for AE, AWB, and AF), and a recording/reproduction system (for compression/decompression, memory control, and display). Some of the systems described above affect a quality of photographed images. For example, an image quality is affected by color temperature of flash, AE (Automatic Exposure) processing, AWB (Automatic White Balance) processing, a color filter array, the number of pixels, gradation conversion, and matrix operations for obtaining brightness/color difference signals. In a digital camera, such factors are controlled for obtaining image data enabling reproduction of high-quality images.

Performance of an optical system and an imaging system varies between models of digital cameras, and processing carried out in a control system and a recording/reproduction system is also different from model to model. Therefore, image characteristics such as color, tone, sharpness, and noise of image data are different between models of digital cameras. Consequently, when image enhancement processing is carried out on image data obtained by a digital camera, processed image data having a high quality that is not dependent on a digital camera model are desired.

In U.S. Patent Laid-Open No. 20020140825, a system has been proposed for carrying out image enhancement processing on image data obtained by a digital camera. In this system, an image processing condition is set for each one of models of digital cameras, and image enhancement processing is carried out on image data obtained by one of the digital cameras according to the image processing condition set therefor.

Furthermore, in Japanese Unexamined Patent Publication No. 11(1999)-161770, an image processing method has been proposed for the filed of medicine. In this method, an image processing condition is set for each type (including a manufacturer and a model) of medical imaging apparatus referred to as an image input modality (such as CR, CT, and MRI apparatuses), and image processing is carried out according to the condition.

In the field of mobile communications, services regarding images are booming for mobile terminals, following recent development of communication technologies and infrastructure of mobile communication networks as well as rapid spread of mobile terminals such as camera-embedded mobile phones. For example, a communication relay server having an image enhancement function has been known. When the server relays an email between mobile terminals, the server carries out image enhancement processing such as color correction, tone correction and sharpness correction on image data attached to the email sent from one of the mobile terminals as a sender. The image data after the processing are then sent to the other mobile terminal as a receiver. Furthermore, if the receiver cannot receive a file of the image data attached to the email, the server stores the enhanced image data and sends an address such as URL of the image data to the receiver. When the receiver accesses the server, the server causes the receiver to download the image data. Such a server exchanges the image data between the mobile terminals via a network.

When image data are exchanged via a network, the image data are compressed for shorter communication time and consequent reduction of a load on a terminal and the network. Especially, in the case of a mobile terminal such as a mobile phone, most of image data obtained by photography with a camera embedded therein are sent to another mobile terminal or a computer. Consequently, in the case of a mobile phone as a receiver, the image data are compressed at a high compression ratio and stored in a storage unit thereof, since a capacity limit thereof is tight. Such highly compressed image data have conspicuous noise due to the compression, and noise reduction is desired when image processing is carried out thereon.

However, due to a rapid increase in the number of models of mobile phones, models of cameras embedded therein also vary. Therefore, image quality changes greatly among image data obtained by cameras of various models. In the case of an ordinary digital camera, header information of image data obtained by the camera often includes accompanying information representing a photography condition and details of processing carried out therein. When image enhancement processing is carried out on such image data, an image processing condition can be set in accordance with a result of analysis of the image data and the accompanying information, regardless of using or not using information on the model of the digital camera. In this manner, differences in image quality between camera models are suppressed. However, the accompanying information is rarely available for a camera built into a mobile phone, and only the information on the model thereof can be used for image enhancement processing. When image processing is carried out on image data obtained by a camera of a mobile phone in this situation, image processing-according to conventional image data analysis cannot suppress the image quality difference between models.

Furthermore, the method described in U.S. Patent Laid-Open No. 20020140825, in which the image processing condition is set for each camera model, is not effective for cameras built into mobile phones, since various models are being released newly and updated.

The same problem is also observed for the method described in Japanese Unexamined Patent Publication No. 11(1999)-161770.

### SUMMARY OF THE INVENTION

The present invention has been conceived based on consideration of the above circumstances. An object of the present invention is therefore to provide a method, an apparatus, a database, and a program for carrying out effective image processing on image data obtained by digital cameras while suppressing image quality differences among models of the digital cameras.

An image processing method of the present invention comprises the steps of:

classifying models of digital cameras into groups of predetermined level ranges according to level of a characteristic of image data due to the models of the digital cameras that obtained the image data:

setting an image processing condition for carrying out correction according to the level range of each of the groups; and

carrying out the correction on image data obtained by a digital camera belonging to any one of the groups by using the image processing condition set therefor.

“A characteristic of image data due to the models of the digital cameras that obtained the image data” refers to a characteristic of the models of the digital cameras represented by the image data obtained by the digital cameras. Therefore, the characteristic of the models of digital cameras (hereinafter referred to as a model characteristic) is meant to be the same as the characteristic of the image data (hereinafter referred to as an image characteristic) attributed to the models of the digital cameras that obtained the image data.

The image characteristic refers to an image characteristic to be corrected. For example, if the correction is color correction, the image characteristic refers to a color characteristic. If the correction is tone correction, the image characteristic refers to a tone characteristic. In the case where the correction is both color correction and tone correction, the image characteristic refers to both a color characteristic and a tone characteristic.

“Classifying models of digital cameras into groups of predetermined level ranges according to level of a characteristic of image data due to the models of the digital cameras that obtained the image data” (that is, according to level of the model characteristic) refers to setting level ranges of the model characteristic and classifying digital cameras whose model characteristic belongs to the same level range into the same group.

“Setting an image processing condition for carrying out correction according to the level range of each of the groups” refers to setting a condition for image enhancement according to the level range corresponding to each of the groups. Setting the image processing condition refers to setting a parameter used in a specific processing method, or selecting a processing method according to the level range, or both the parameter setting and the processing method selection.

In other words, the image processing method of the present invention is different from a conventional image processing method that sets an image processing condition for each model of digital camera. In the method of the present invention, digital cameras whose model characteristic is similar (that is, digital cameras whose model characteristic belongs to the same level range) are classified into the same group, and the image processing condition is set for each of the groups. The correction is then carried out on image data obtained by a digital camera of any one of the groups according to the image processing condition set for the group.

The model characteristic includes various types such as a color characteristic, a tone characteristic, a sharpness characteristic, and a noise characteristic. For example, if classification is carried out according to a tone characteristic as well as a noise characteristic on a digital camera (hereinafter called a digital camera 1) whose tone characteristic is “soft” and whose noise characteristic is “high” and a digital camera (hereinafter called a digital camera 2) whose tone characteristic is also “soft” but whose noise characteristic is “low”, the digital camera 1 is classified into a group having soft tone and high noise while the digital camera 2 is classified into a group having soft tone and low noise. If the classification is carried out in the above manner according to the level ranges of various types of model characteristic, the number of the groups increases. Consequently, setting the image processing condition therefor becomes complex and inefficient. Therefore, in the present invention, in the case where the number of the types of the model characteristic is not one, the classification, the image processing condition setting, and the correction are preferably carried out for each of the types of the model characteristic. In order to classify the model characteristic according to the types, the level ranges of the model characteristic of one of the types (such as color, tone, or sharpness) are set, and digital cameras belonging to the same level range of model characteristic of the type are grouped together. The same classification is then carried out for all the types. For example, if image data are to be subjected to tone correction and noise reduction, the types of model characteristic to be used for the classification are the tone characteristic and the noise characteristic. Therefore, if the characteristic has level ranges of “soft”, “immediate”, and “hard” tones, the digital camera 1 and the digital camera 2 described above are classified into the group of soft tone while digital cameras having hard tones and intermediate tones are classified into the groups of hard tone and intermediate tone, respectively. If the noise characteristic has level ranges of “low” noise, “intermediate” noise, and “high” noise, the digital camera 1 is classified into the group of high noise while the digital camera 2 is classified into the group of low noise. If a digital camera has an intermediate level of noise, the camera is classified into the group of intermediate noise. In this manner, digital cameras classified into the same group for one of the types of model characteristic such as tone (the digital cameras 1 and 2, for example) are not necessarily classified into the same group for the remaining types of model characteristics, such as noise characteristics. Therefore, by classifying the digital cameras into the groups of the same type of model characteristic, the configuration of the groups is not complex and the image processing condition can be set simply for efficient processing.

In the case where the digital cameras are classified according to the types of model characteristics, the image processing condition is set as an image processing condition for carrying out the correction according to the level range of the model characteristic for each of the groups. Therefore, a parameter in a specific processing method may be set for each of the groups according to the type of model characteristic. Alternatively, a processing method may be selected in accordance to the level range of each of the groups, or both the processing method selection and the parameter setting may be used.

For example, if digital cameras are classified into groups corresponding to “low”, “intermediate”, and “high” sharpness, a parameter in a sharpness correction method may be set to a value for correcting the sharpness to high, intermediate, and low sharpness, according to the level ranges of the respective groups. Alternatively, methods for correcting the sharpness to high, intermediate, and low sharpness may be adopted for the respective groups.

An image processing apparatus of the present invention comprises:

storage means for storing:

models of digital cameras classified into groups of predetermined level ranges according to level of a characteristic of image data due to the models of the digital cameras that obtained the image data;

the groups; and

image processing conditions set for carrying out correction according to the level ranges of the respective groups while relating the models, the groups, and the conditions to each other;

search means for making judgment as to which of the groups a digital camera belongs to from the model of the digital camera that obtained image data to be corrected and for carrying out reading of the image processing condition set for the group that has been judged while referring to the storage means; and

correction execution means for carrying out the correction on the image data obtained by the digital camera by using the image processing condition found by the search means.

It is preferable for the storage means of the image processing apparatus of the present invention to store the models, the groups, and the image processing conditions in relation to each other for respective types of the characteristic in the case where the correction is carried out regarding the types of the characteristic. In this case, the search means and the correction execution means carry out the judgment, the reading, and the correction for each of the types of the characteristic.

The image processing method and the image processing apparatus can be used for dealing with image data obtained by a digital camera built into a mobile phone.

A first database of the present invention stores:

models of digital cameras classified into groups of predetermined level ranges according to level of a characteristic of image data due to the models of the digital cameras that obtained the image data;

the groups; and

image processing conditions set for carrying out correction according to the level ranges of the respective groups while relating the models, the groups, and the image processing conditions to each other.

A second database of the present invention stores the models, the groups and the image processing conditions in relation to each other for respective types of the characteristic in the case where the characteristic has the types.

A first program of the present invention causes a computer to execute:

search processing for making judgment as to which of the groups a digital camera that obtained image data to be corrected belongs to from the model of the digital camera and for carrying out reading of the image processing condition set for the group that has been judged while referring to the first database; and

correction execution processing for carrying out the correction on the image data obtained by the digital camera by using the image processing condition found through the search processing.

A second program of the present invention causes a computer to execute:

search processing for making judgment as to which of the groups a digital camera that obtained image data to be corrected belongs to for each of the types of the characteristic from the model of the digital camera and for carrying out reading of the image processing condition set for the group that has been judged while referring to the second database; and

correction execution processing for carrying out the correction on the image data obtained by the digital camera by using the image processing condition found through the search processing for each of the types.

According to the image processing method and the image processing apparatus of the present invention, the model characteristic is divided into the predetermined level ranges, and digital cameras belonging to the same level range of model characteristic are classified into the same group. The correction is then carried out on image data obtained by a digital camera belonging to any one of the groups according to the image processing condition set for the group in advance. Therefore, the correction can be carried out according to the respective models, and a difference in image quality caused by the models can be suppressed. At the same time, the image processing condition does not need to be set for each of the models, which makes execution of the correction efficient.

Furthermore, when the models are classified, each of the digital cameras is classified into one of the groups whose level range agrees with the level range of the digital camera. Therefore, a new digital camera can be easily dealt with in this method. If which of the groups the model characteristic of the new camera belongs to is known, the image processing condition has already been set for the group, and the correction can be carried out easily on image data obtained by the new camera.

In the case where the correction is carried out for a plurality of types of image characteristic, the classification of the digital cameras, the setting of the image processing conditions, and the correction are carried out for each of the types. In this manner, the groups can be configured simply and the image processing conditions can be set easily. Consequently, the correction can be carried out efficiently, and the types of image characteristic can be increased or decreased easily and flexibly according to content of the correction.

The image processing method and the image processing apparatus of the present invention can be especially effective for digital cameras built into mobile phones whose model change is frequent and whose accompanying information for image correction includes only model information or the like despite of comparatively low image quality that needs to be corrected.

The databases and the programs of the present invention realize the image processing method and the image processing apparatus of the present invention.

### BRIEF DESCRIPTION OF THE DRAWINGS

FIG. 1 is a block diagram showing the configuration of an image processing apparatus 1 as an embodiment of the present invention;

FIG. 2 shows a database 25 used in the image processing apparatus 1 shown in FIG. 1;

FIG. 3 is a chart for obtaining a sharpness characteristic of digital cameras;

FIG. 4 shows an example of the sharpness characteristic;

FIG. 5 shows a result of search for a digital camera of model A;

FIG. 6 is a flow chart showing the operation of the image processing apparatus 1; and

FIG. 7 shows an example of a modification to the database of FIG. 2.

### DESCRIPTION OF THE PREFERRED EMBODIMENTS

Hereinafter, an embodiment of the present invention will be explained with reference to the accompanying drawings.

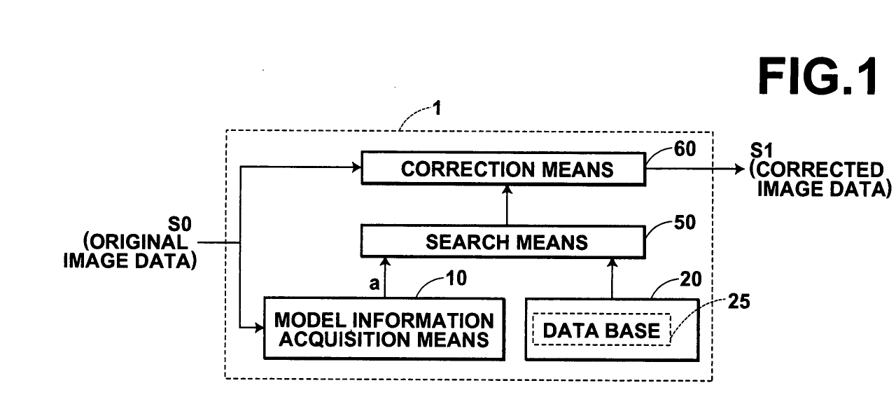

FIG. 1 is a block diagram showing the configuration of an image processing apparatus 1 as the embodiment of the present invention. The image processing apparatus 1 carries out color correction, tone correction, sharpness correction, and noise reduction on image data obtained by a digital camera. As shown in FIG. 1, the image processing apparatus 1 comprises model information acquisition means 10, storage means 20, search means 50, and correction means 60. The model information acquisition means 10 obtains information on the model of the digital camera that obtains image data (original image data) S0. The storage means 20 stores a database 25. The search means 50 searches the database 25 for a color correction condition, a tone correction condition, a sharpness correction condition, and a noise reduction condition for the original image data S0 according to the model information a on the digital camera. The correction means 60 carries out the correction on the original image data S0 according to the conditions found by the search means 50, and obtains corrected image data S1.

The model information acquisition means 10 obtains the model information a from header information of the original image data S0.

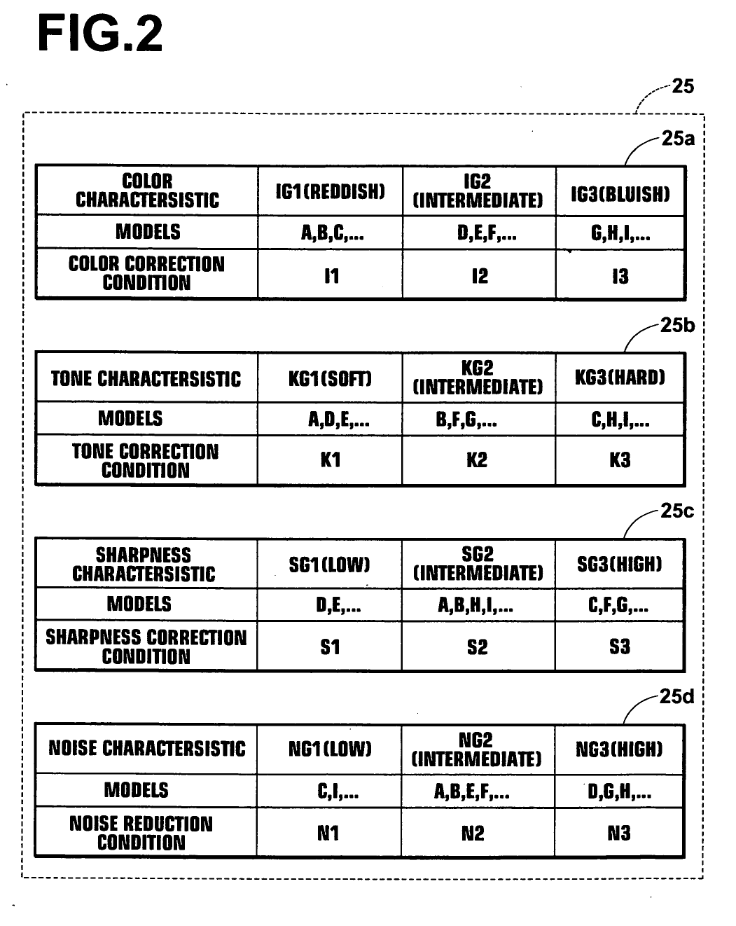

The database 25 is stored in advance in the storage means 20, and FIG. 2 shows details thereof. As shown in FIG. 2, the database 25 comprises 4 parts (25a˜25d) corresponding to the types of image (or model) characteristic to be corrected by the image processing apparatus 1 (that is, color, tone, sharpness, and noise characteristics in this example). The database 25 stores groups corresponding to predetermined level ranges of the color characteristic, the tone characteristic, the sharpness characteristic, and the noise characteristic as the types of model characteristic of digital cameras. The database 25 also stores model names of the digital cameras whose model characteristic agrees with the ranges of the respective groups and correction conditions for the corresponding groups. The database 25 stores the groups, the model names, and the correction conditions in relation to each other.

The part 25a is used for the color correction. As shown in FIG. 2, the color characteristic of digital cameras are divided into 3 groups corresponding to 3 level ranges, namely “reddish”, “intermediate”, and “bluish”, and the 3 groups are named IG1, IG2, and IG3, respectively. More specifically, digital cameras whose color characteristic is reddish belong to the group IG1 and the model names thereof are A, B, and C. The correction condition (the color correction condition) set for the group IG1 is I1, and is used for the color correction on image data obtained by any one of the digital cameras (A, B or C) whose color characteristic is reddish. Likewise, digital cameras whose color characteristic is intermediate are models D, E, and F comprising the group IG2. The color correction condition for the group IG2 is I2, and is used for the color correction on image data obtained by any one of the digital cameras (D, E, or F) whose color characteristic is intermediate. Digital cameras whose color characteristic is bluish are models G, H, and I comprising the group IG3. The color correction condition for the group IG3 is I3, and is used for the color correction on image data obtained by any one of the digital cameras (G, H, or I) whose color characteristic is bluish.

The part 25b is used for the tone correction. As shown in FIG. 2, the tone characteristic is divided into 3 groups corresponding to 3 level ranges, namely “soft”, “intermediate”, and “hard”, and the 3 groups are named KG1, KG2, and KG3, respectively. More specifically, digital cameras whose tone characteristic is soft belong to the group KG1, and the model names thereof are A, D, and E. The correction condition (the tone correction condition) set for the group KG1 is K1, and is used for the tone correction on image data obtained by any one of the digital cameras (A, D, or E) whose tone characteristic is soft. Likewise, digital cameras whose tone characteristic is intermediate are the models B, F, and G comprising the group KG2. The tone correction condition for the group KG2 is K2, and is used for the tone correction on image data obtained by any one of the digital cameras (B, F, or G) whose tone characteristic is intermediate. Digital cameras whose tone characteristic is hard are the models C, H, and I comprising the group KG3. The tone correction condition for the group KG3 is K3, and is used for the tone correction on image data obtained by any one of the digital cameras (C, H, or I) whose tone characteristic is hard.

The part 25c is used for the sharpness correction. As shown in FIG. 2, the sharpness characteristic is divided into 3 groups corresponding to 3 level ranges, namely “low”, “intermediate”, and “high”, and the 3 groups are named SG1, SG2, and SG3, respectively. More specifically, digital cameras whose sharpness characteristic is low belong to the group SG1, and the model names thereof are D and E. The correction condition (the sharpness correction condition) set for the group SG1 is S1, and is used for the sharpness correction on image data obtained by either one of the digital cameras (D or E) whose sharpness characteristic is low. Likewise, digital cameras whose sharpness characteristic is intermediate are the models A, B, H, and I comprising the group SG2. The sharpness correction condition for the group SG2 is S2, and is used for the sharpness correction on image data obtained by anyone of the digital cameras (A, B, H, or I) whose sharpness characteristic is intermediate. Digital cameras whose sharpness characteristic is high are the models C, F, and G comprising the group SG3. The sharpness correction condition for the group SG3 is S3, and is used for the sharpness correction on image data obtained by any one of the digital cameras (C, F, or G) whose sharpness characteristic is high.

The part 25d is used for the noise reduction. As shown in FIG. 2, the noise characteristic is divided into 3 groups corresponding to 3 level ranges, namely “low”, “intermediate”, and “high”, and the 3 groups are named NG1, NG2, and NG3, respectively. More specifically, digital cameras whose noise characteristic is low belong to the group NG1 and the model names thereof are C and I. The correction condition (the noise reduction condition) set for the group NG1 is N1, and is used for the noise reduction on image data obtained by either one of the digital cameras (C or I) whose noise characteristic is low. Likewise, digital cameras whose noise characteristic is intermediate are the models A, B, E, and F comprising the group NG2. The noise reduction condition for the group NG2 is N2, and is used for the noise reduction on image data obtained by any one of the digital cameras (A, B, E, or F) whose noise characteristic is intermediate. Digital cameras whose noise characteristic is high are the models D, G, and H comprising the group NG3. The noise reduction condition for the group NG3 is N3, and is used for the noise reduction on image data obtained by any one of the digital cameras (D, G, or H) whose noise characteristic is high.

As has been described above, digital cameras are classified into the groups belonging to the same level ranges for each of the types of model characteristic, according to the models thereof. When the digital cameras are classified, a subject may be photographed by the respective cameras so that images obtained in this manner can be evaluated visually for determination of the level ranges thereof. Alternatively, charts regarding the respective types of model characteristic may be photographed so that images obtained in this manner can be analyzed for determination of the level ranges. For example, images obtained by photographing a Macbeth color chart may be evaluated visually. Alternatively, color patches therein may be measured. In this manner, the level ranges can be understood for the color characteristic. For the tone characteristic, a gray chart may be photographed so that images thereof are evaluated visually or analyzed.

For the noise characteristic, the level ranges thereof may be understood by WS (Wiener Spectrum) or RMS (standard deviation of pixel values) of images obtained by photography of a gray chart, for example.

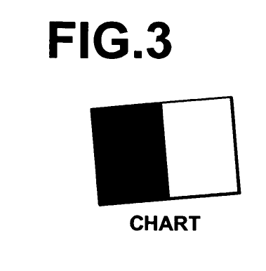

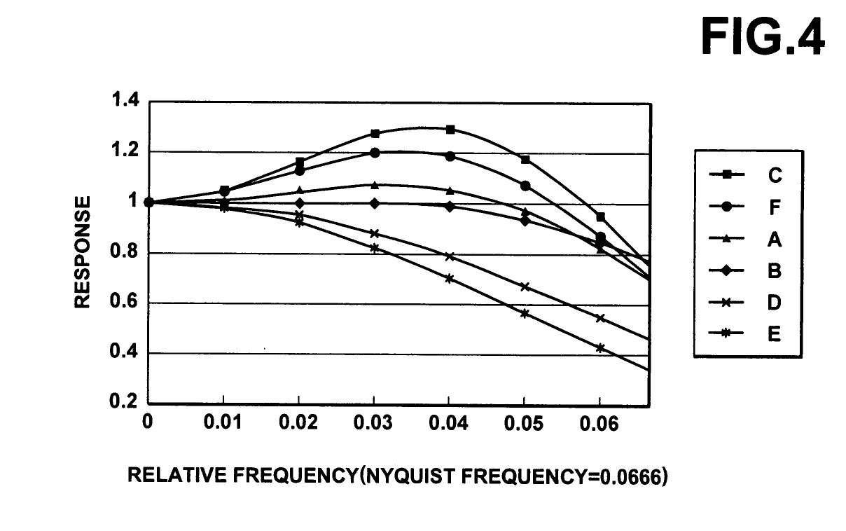

For measuring sharpness, a slanting edge may be photographed as defined in ISO 12233, for example. Alternatively, a chart that is easier to analyze may be used for digital cameras having low resolution (such as those built into mobile phones). For example, a chart shown in FIG. 3 may be photographed and edge detection is carried out on images obtained by the photography. By carrying out Fourier transform on an edge characteristic, a distribution of frequency response is obtained, and the sharpness characteristic is found based on the distribution. FIG. 4 shown an example of the distribution found for the digital cameras of the various models. The sharpness characteristic is higher in order of the models C, F (belonging to high sharpness), A, B (belonging to intermediate sharpness), D and E (belonging to low sharpness).

The database 25 has been generated in the above manner.

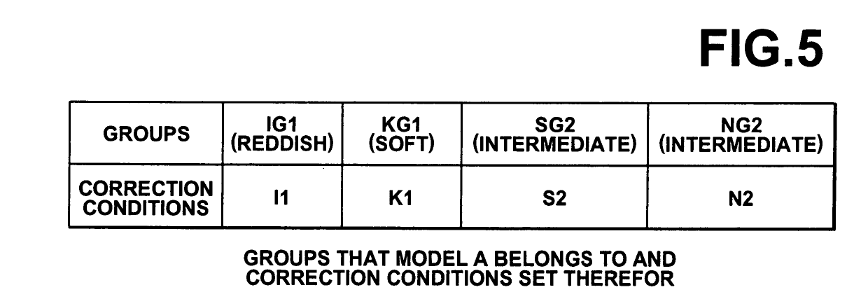

The search means 50 of the image processing apparatus 1 searches for the database 25 for the groups to which the digital camera that obtained the original image data S0 belongs for the color characteristic, the tone characteristic, the sharpness characteristic, and the noise characteristic, based on the model information a of the digital camera obtained by the model information acquisition means 10. The search means 50 then finds the correction conditions set for the respective groups that have been found, and provides the conditions to the correction means 60. FIG. 5 shows a result of search for the digital camera A. The digital camera A belongs to the group IG1 (reddish colors), KG1 (soft tones), SG2 (intermediate sharpness), and NG2 (intermediate noise). Therefore, the correction conditions for the respective groups are I1, K1, S2, and N2.

The correction means 60 carries out correction processing on the original image data S0 according to the correction conditions found by the search means 50 for the respective types of characteristic, and obtains the corrected image data S1. The correction means 60 may carry out the correction processing in order of the color correction, the tone correction, the sharpness correction, and the noise reduction, for example. Alternatively, the correction means 60 may generate integrated correction conditions (such as a look-up table) using the color correction condition, the tone correction condition, the sharpness correction condition, and the noise reduction condition so that the correction processing can be carried out at once according to the integrated conditions.

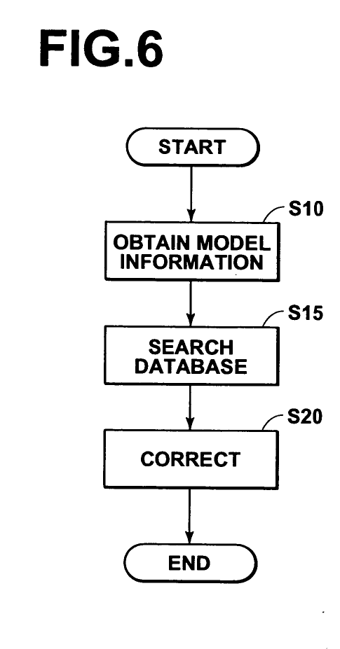

FIG. 6 is a flow chart showing the operation of the image processing apparatus 1. For carrying out the correction processing on the image data S0 obtained by the digital camera, the model information acquisition means 10 of the image processing apparatus 1 firstly obtains the model information a of the digital camera (Step S10). The search means 50 then searches the database 25 stored in the storage means 20 based on the model information a, and finds the groups the digital camera belongs to and the correction conditions set for the groups regarding the color correction, the tone correction, the sharpness correction, and the noise reduction (Step S15). The correction means 60 carries out the color correction, the tone correction, the sharpness correction and the noise reduction on the original image data S0 according to the correction conditions found by the search means 50, and obtains the corrected image data S1 (Step S20) to end the operation.

As has been described above, according to the image processing apparatus 1 of the present invention, the model characteristic of digital cameras is divided into the plurality of level ranges for each of the types of model characteristic, and digital cameras are classified into the groups belonging to the same level ranges of model characteristic of the respective types. The image data obtained by the digital camera belonging to one of the groups are corrected by using the correction condition set for the group. Therefore, the correction can be carried out according to the model of the digital camera, and an image quality difference between the models can be suppressed. At the same time, since the correction conditions do not need to be set for each model, the correction becomes efficient.

Since digital cameras are classified into the groups belonging to the same level ranges, a new digital camera can be easily classified. If the groups to which the model characteristic of the new camera belongs are known, the correction can be carried out easily on image data of the new digital camera by using the correction conditions set for the groups in advance.

Furthermore, classification of the digital cameras, the setting of the correction conditions, and the correction are carried out for each of the types of model characteristic. Consequently, the types of model characteristic to be corrected can be increased or decreased easily and flexibly according to content of the correction.

When the database 25 is generated, digital cameras are classified for each of the types of model characteristic and the correction conditions are set for the respective groups. Therefore, developers can work in teams. For example, if the image processing apparatus 1 shown in FIG. 1 is to be developed, developers can work in teams for the color characteristic, the tone characteristic and so on. In this manner, time necessary for developing the apparatus can be shortened, and each of the developers can work in one of the teams of a field he/she specializes in. In this manner, the image processing apparatus can be developed efficiently.

Although the preferred embodiment of the present invention has been explained, the present invention is not limited to the embodiment described above. Within the scope of the present invention, various modifications can be made thereto.

For example, although the image processing apparatus 1 in the above embodiment carries out the color correction, the tone correction, the sharpness correction, and the noise reduction on the image data, the types of the correction can be increased or decreased. In this case, a database corresponding to the types of model characteristic to be corrected may be used. For example, if no noise reduction is carried out, no search for noise reduction is carried out regardless of whether or not the database includes the part on the noise characteristic. In the case where contrast correction is carried out in addition to the correction processing described above, the database 25 shown in FIG. 2 is added with a part on a contrast characteristic. When the contrast correction is carried out, a group to which the digital camera belongs is found from the model information thereof. A contrast correction condition set for the group is also searched for and provided to the correction means 60. Moreover, a classification method combining the types of model characteristic may be used according to a correction method. For example, sharpness correction and noise reduction (mainly mosquito noise reduction) can be carried out at once by correcting a gain for a high frequency component according to likelihood of an edge in an intermediate frequency component in image data and by adjusting the high frequency component with use of the corrected gain. In this case, setting one parameter enables correction of the plurality of types of model characteristic. Therefore, a combination of the types of model characteristic is dealt with as another type of characteristic, and the digital cameras are classified regarding the type. In the above example, the sharpness characteristic and the noise characteristic are combined to form one type of characteristic, and the digital cameras are classified regarding the type. For each of groups of the digital cameras, the gain is set for high frequency component and the correction is carried out according to the gain. In this example, the noise reduction mainly refers to mosquito noise reduction. Therefore, the sharpness characteristic and the mosquito noise characteristic may be combined to form one type of characteristic so that another noise characteristic can be combined with another type of model characteristic. In this case, the digital camera classification, the correction condition setting, and the correction are carried out according to the combined type of characteristic.

The predetermined level ranges and the number of the level ranges of model characteristic may be changed. For example, although the color characteristic is divided into the 3 groups (reddish, intermediate, and bluish) in the image processing apparatus 1 in the above embodiment, the color characteristic may be divided in more details, increasing the number of the groups therefor.

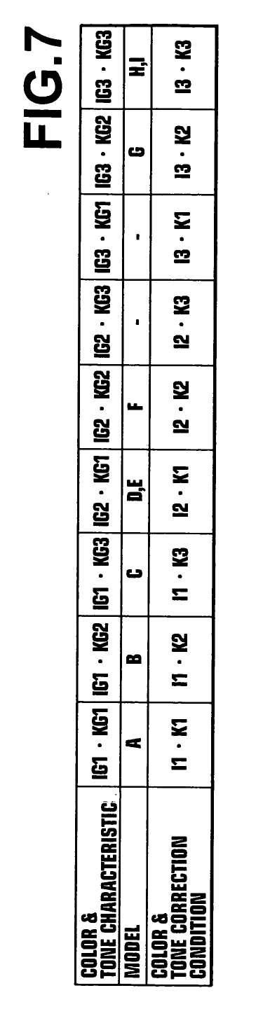

In addition, the specific structure of the database is not limited to that of the database 25 shown in FIG. 2. That is, the database may be of a structure other than that in which level ranges, model types, and correction conditions are correlated for each image quality characteristic (such as color characteristics and tone characteristics). For example, a plurality of image characteristics, their level ranges, and correction conditions corresponding thereto may be grouped as combined classifications and combined correction conditions. Then, the combined classifications and combined correction conditions may be correlated to the models. Specifically, the database 25 shown in FIG. 2 may be modified so that 81 (3×3×3×3) groups comprising “IG1, KG1, SG1, NG1”, “IG1, KG1, SG1, NG2”. “IG3, KG3, SG3, NG3” are set to be combined classifications. The combined classifications are correlated to 81 combined correction conditions comprising “I1, K1, S1, N1” . . . “I3, K3, S3, N3”, and models of digital cameras. In the case that the database is of the configuration as described above, model B would correspond to the combined classification of “IG1, KG2, SG2, NG2”, and the combined correction conditions of “I1, K2, S2, N2”. Note that when the combined classifications and the combined correction conditions are grouped, all of the image characteristics and the correction conditions may be grouped. Alternatively, combinations of desired image characteristics and correction conditions corresponding to the combinations of the desired image characteristics may be grouped. For example, the database 25 shown in FIG. 2 may be modified so that the color and tone characteristics are grouped into combined color and tone classifications, with corresponding combined color and tone correction conditions, while the sharpness and noise characteristics are grouped into combined sharpness and noise classifications, with corresponding combined sharpness and noise correction conditions. FIG. 7 shows an example in which the color correction database 25a and the tone correction database 25b of the database 25 shown in FIG. 2 are combined. In the case that such a database as shown in FIG. 7 is employed, correction processes may be executed in order, in the same manner as the case that the database 25 of FIG. 2 is employed. Alternatively, the correction processes may be performed simultaneously, based on the combined correction conditions. The database 25 may also be modified so that combined sharpness and noise classifications and corresponding combined sharpness and noise correction conditions are provided in addition to the combined color and tone classifications and the corresponding combined color and tone correction conditions. In the case that such a database is employed, each of the plurality of correction processes corresponding to the combined correction conditions (for example, color correction and tone correction corresponding to the combined color and tone correction conditions) may be performed simultaneously, or in order.

Although no explanation is provided in detail regarding how the correction conditions are set and how the correction is carried out by the correction means 60 in the above embodiment, any known techniques can be applied thereto. The correction conditions may be used directly for the correction by the correction means 60. Alternatively, in the case where the correction means 60 analyzes the original image data, the correction conditions may be used as conditions for correcting correction conditions that are set by the correction means 60 based on the analysis. For example, the color correction condition set for the group IG1 may be used directly as the condition for correcting the image data obtained by a digital camera belonging to the group. In this case, the correction means 60 uses the color correction condition as it is for the color correction. Alternatively, if the correction means 60 sets a color correction condition by analyzing the image data, the color correction condition set for the group IG1 in the database 25 is used as the condition for correcting the color correction condition set by the correction means. In this case, the color correction condition in the database 25 corrects the condition set by the correction means 60 for suppressing red.

Since the level ranges of the groups are divided into the predetermined ranges, the correction condition for each of the groups may be set as a representative value for a predetermined level in the corresponding range. In this case, the representative value is generally an intermediate value in the range. However, the value is not necessarily the intermediate value, and any value within the range maybe used.

In the image processing apparatus 1, the digital camera that obtained the image data is assumed to belong to any one of the groups in the database 25 for each of the types of characteristic. However, there may be a digital camera that does not belong to any one of the groups in the database 25 for one or more or all of the types of characteristic. In this case, no correction may be carried out since the characteristic of the camera deviates too much from the ordinary range or ranges. Alternatively, predetermined default conditions (such as the conditions set for the intermediate groups) may be used, or the correction conditions may be set only through analysis of the image data.

The image processing apparatus 1 may be a stand-alone apparatus used in a DPE store, or used in a network as a relay server for mobile phones, for example.

What is claimed is:

1. An image processing method comprising the steps of:
carrying out classification of models of digital cameras into groups of predetermined level ranges according to level of a characteristic of image data due to the models of the digital cameras that obtained the image data:
carrying out setting of an image processing condition for carrying out correction according to the level range of each of the groups; and
carrying out the correction on image data obtained by a digital camera belonging to any one of the groups by using the image processing condition set therefor.

2. The image processing method according to claim 1, wherein
the characteristic includes a plurality of types and
the classification, the setting, and the correction are carried out for each of the types of the characteristic.

3. The image processing method according to claim 1, wherein the digital cameras are digital cameras built into mobile phones.

4. The image processing method according to claim 2, wherein the digital cameras are digital cameras built into mobile phones.

5. An image processing apparatus comprising:
storage means for storing:
models of digital cameras classified into groups of predetermined level ranges according to level of a characteristic of image data due to the models of the digital cameras that obtained the image data;
the groups; and
image processing conditions set for carrying out correction according to the level ranges of the respective groups while relating the models, the groups, and the image processing conditions to each other;
search means for making judgment as to which of the groups a digital camera belongs to from the model of the digital camera that obtained image data to be corrected and for carrying out reading of the image processing condition set for the group that has been judged while referring to the storage means; and
correction execution means for carrying out the correction on the image data obtained by the digital camera by using the image processing condition found by the search means.

6. The image processing apparatus according to claim 5,
the characteristic including a plurality of types,
the storage means storing the models, the groups, and the image processing conditions in relation to each other for each of the types of the characteristic; and
the search means and the correction execution means carrying out the judgment, the reading, and the correction for each of the types of the characteristic.

7. The image processing apparatus according to claim 5, wherein the digital cameras are digital cameras built into mobile phones.

8. The image processing apparatus according to claim 6, wherein the digital cameras are digital cameras built into mobile phones.

9. A database storing:
models of digital cameras classified into groups of predetermined level ranges according to level of a characteristic of image data due to the models of the digital cameras that obtained the image data;
the groups; and
image processing conditions set for carrying out correction according to the level ranges of the respective groups while relating the models, the groups, and the image processing conditions to each other.

10. The database according to claim 9, wherein
the characteristic includes a plurality of types and
the database stores the models, the groups and the image processing conditions in relation to each other for the respective types of the characteristic.

11. A program causing a computer to execute:
search processing for making judgment as to which of the groups a digital camera that obtained image data to be corrected belongs to from the model of the digital camera and for carrying out reading of the image processing condition set for the group that has been judged while referring to the database in claim 9; and
correction execution processing for carrying out the correction on the image data obtained by the digital camera by using the image processing condition found through the search processing.

12. A program causing a computer to execute:
search processing for making judgment as to which of the groups a digital camera that obtained image data to be corrected belongs to for each of the types of the characteristic from the model of the digital camera and for carrying out reading of the image processing condition set for the group that has been judged while referring to the database in claim 10; and
correction execution processing for carrying out the correction on the image data obtained by the digital camera by using the image processing condition found through the search processing for each of the types.
